(19) United States
(12) Patent Application Publication
(10) Pub. No.: US 2010/0023257 A1
(43) Pub. Date: Jan. 28, 2010

(54) NAVIGATION APPARATUS

(75) Inventor: Hiroshi Machino, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, Tokyo (JP)

(21) Appl. No.: 12/513,619

(22) PCT Filed: Oct. 3, 2007
(86) PCT No.: PCT/JP2007/069382

§ 371 Date: May 5, 2009

(30) Foreign Application Priority Data
Dec. 11, 2006 (JP) 2006-333495

(51) Int. Cl. G01C 21/36

(52) U.S. Cl. 701/201

(57) ABSTRACT

A navigation apparatus includes: a map data storage means 11, 12, and 5 for storing map data; a display means 2 for displaying intersection information including information about a plurality of destination areas at an intersection located forwardly in a traveling direction on the basis of map data read from the map data storage means; an instructing means 3 for instructing the traveling direction by selecting one destination area from the information about the plurality of destination areas included in the intersection information displayed on the display means; a route generating unit 150 for generating a route on the basis of destination areas which are selected sequentially under instructions provided by the instructing means; a route storage unit 17 for storing the route generated by the route generating unit; and a route guidance unit 140 for guiding along the route stored in the route storage unit, and for providing a guidance.

### FIELD OF THE INVENTION

The present invention relates to a navigation apparatus which guides the user to a destination or a via-place (referred to as “destination or the like” from here on). More particularly, it relates to a technology for generating a route extending to a destination or the like even if any destination or the like is not set up.

### BACKGROUND OF THE INVENTION

When a user sets up a destination or the like which the user desires by inputting its address, a facility name, a surrounding facility, or the like, a conventional vehicle-mounted navigation apparatus carries out a route search, performs a display or a route guidance by voice according to a route which the vehicle-mounted navigation apparatus has searched for, and guides the user to the destination or the like. As a method of inputting the destination or the like to the navigation apparatus, various methods, such as an address search, a facility category search, a zip code search, and an intersection search, are known. However, these methods require operations, such as a complicated key operation, an input check, implementation of a route searching process, a display of a map screen including the destination or the like, a confirmation operation of confirming the destination or the like, and a guidance start operation.

For the user, these operations for inputting the destination or the like are complicated and troublesome for the user. When the user does not know the address of the destination or the like, or when the user does not know the category to which the destination or the like belongs because there are too many facility categories, the user needs to redo such input operations repeatedly, and therefore it takes much time to complete the setting of the destination or the like.

Patent reference 1 discloses, as a related technology, a vehicle-mounted navigation apparatus which can display traffic restriction information when a vehicle approaches an intersection even if any destination is not set up. This vehicle-mounted navigation apparatus displays, as a road sign mark or an arrow, static traffic restriction data recorded in a map database and dynamic traffic restriction data which the vehicle-mounted navigation apparatus has received from an FM multiplex broadcast or a beacon and stores in an infrastructure data memory on an enlarged view of an intersection in the traveling direction, which is enlarged and displayed to a display unit, or displays roads along which the vehicle cannot travel in distinction from other roads from the static traffic restriction data and the dynamic traffic restriction data.

Patent reference 2 discloses a vehicle guidance method for use in a navigation apparatus which is constructed in such a way as to be able to perform a route guidance for a vehicle even if any destination is not inputted. According to this vehicle guidance method, image data about road signs, data about a correspondence between intersection construction links and destination areas, and the absolute geographic coordinates of an entry point to each of the areas are included in a map database, and, when the vehicle approaches an intersection with a road sign, the road sign is displayed on a display screen. When the vehicle passes through the intersection, an destination area to which the vehicle will be headed is identified from the data about the correspondence between intersection construction links and destination areas, and, when the vehicle then travels from this intersection in the same direction as that of the destination area to which the vehicle has been headed, an entry point to the destination area is set as the destination, whereas when the vehicle then travels from the intersection in a direction different from that of the destination area to which the vehicle has been headed, an entry point to the new destination area is set as the destination, so that a guidance route to the destination is determined and is displayed on a map.
[Patent reference 1] JP,2001-0844B7,A
[Patent reference 2] JP,10-281787,A

A problem with conventional navigation apparatuses is that, as mentioned above, the operations for inputting a destination or the like are complicated and troublesome for the user, and, when the user does not know the address of the destination or the like, or when the user does not know the category to which the destination or the like belongs because there are too many facility categories, the user needs to redo the input operations repeatedly, and therefore it takes much time to complete the setting of the destination or the like.

The present invention is made in order to solve the above-mentioned problem, and it is therefore an object of the present invention to provide a navigation apparatus which can set up a route extending to a destination or a via-place which the user desires even if neither destination nor via-place is set up.

### DISCLOSURE OF THE INVENTION

In order to solve the aforementioned problem, a navigation apparatus in accordance with the present invention includes: a map data storage means for storing map data; a display means for displaying intersection information including information about a plurality of destination areas at an intersection located forwardly in a traveling direction on a basis of map data read from the map data storage means; an instructing means for instructing the traveling direction by selecting one destination area from the information about the plurality of destination areas included in the intersection information displayed on the display means; a route generating unit for generating a route on a basis of destination areas which are selected sequentially under instructions provided by the instructing means; a route storage unit for storing the route generated by the route generating unit; and a route guidance unit for guiding along the route stored in the route storage unit, and for providing a guidance.

As previously explained, the navigation apparatus in accordance with the present invention is constructed in such a way as to repeat the operation of instructing the traveling direction at an intersection by selecting a destination area from among the plurality of destination areas included in the displayed intersection information, generate a route on the basis of destination areas which are selected sequentially through this operation to store the route, and perform a route guidance along this stored route and provide a guidance. Therefore, the navigation apparatus can acquire a route which is extending up to a destination or a via-place which the user desires even if the navigation apparatus does not set up the destination or the via-place. For example, the navigation apparatus can generate a route by instructing the user who does not know the route to the destination or the via-place to make a left or right turn at the next intersection. Although a route which a navigation apparatus automatically determines does not meet the user's intention, the navigation apparatus in accordance with the present invention can set up a route which meets the user's intention.

### BRIEF DESCRIPTION OF THE FIGURES

FIG. 1 is a block diagram showing the structure of a navigation apparatus in accordance with Embodiment 1 of the present invention;

FIG. 2 is a flow chart showing an operation of the navigation apparatus in accordance with Embodiment 1 of the present invention;

FIG. 3 is a view showing an example of a current position screen displayed in the navigation apparatus in accordance with Embodiment 1 of the present invention;

FIG. 4 is a view showing an example of a screen including an intersection guide figure and displayed in the navigation apparatus in accordance with Embodiment 1 of the present invention;

FIG. 5 is a view showing an example of the intersection guide figure displayed in the navigation apparatus in accordance with Embodiment 1 of the present invention;

FIG. 6 is a view showing in detail the intersection guide figure shown in FIG. 5;

FIG. 7 is a view showing the intersection guide figure shown in FIG. 6 in further detail;

FIG. 8 is a view showing the intersection guide figure shown in FIG. 6 in further detail; and

FIG. 9 is a view showing an example of a detailed information screen displayed in the navigation apparatus in accordance with Embodiment 1 of the present invention.

### PREFERRED EMBODIMENTS OF THE INVENTION

Hereafter, in order to explain this invention in greater detail, the preferred embodiments of the present invention will be described with reference to the accompanying drawings.

### Embodiment 1

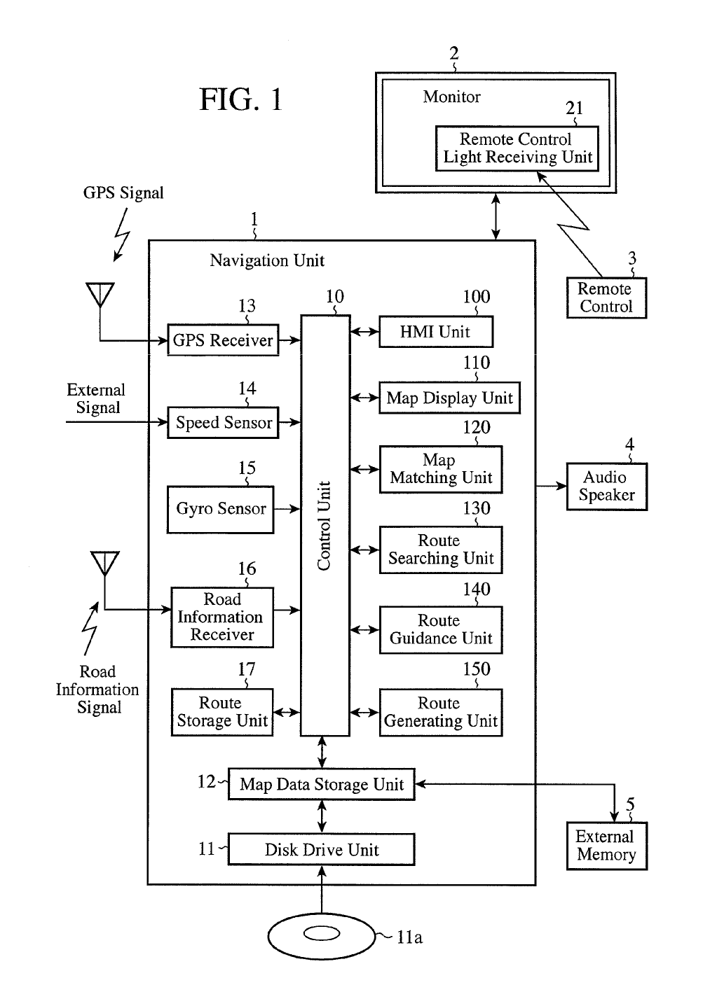

FIG. 1 is a block diagram showing the structure of a navigation apparatus in accordance with Embodiment 1 of the present invention. This navigation apparatus is comprised of a navigation unit 1, a monitor 2, a remote controller (abbreviated as a “remote control” from here on) 3, an audio speaker 4, and an external memory 5.

The navigation unit 1 forms the heart of the navigation apparatus, and carries out processes, such as a map display, a route search, a route display, and a route guidance. In the route guidance process, when the vehicle approaches an intersection located forwardly in the traveling direction of the vehicle, the navigation unit performs a route guidance by voice, and so on while displaying intersection information about the intersection. Road information, destination area information, famous facility or scenic spot area information, address information, etc. are included in the intersection information. A “destination area” in accordance with the present invention is specified by destination area information, famous facility area information, scenic spot area information, address information, or the like. The details of this navigation unit 1 will be mentioned below.

The monitor 2 corresponds to a display means in accordance with the present invention, and consists of, for example, an LCD (Liquid Crystal Display). This monitor 2 displays a map, a vehicle position mark, road information about an intersection located forwardly in the traveling direction, destination area information, famous facility or scenic spot area information, address information, or other various messages according to a display signal sent from the navigation unit 1. A remote control light receiving unit 21 is disposed in this monitor 2. The remote control light receiving unit 21 receives a light signal sent thereto from the remote control 3, and sends the light signal to the navigation unit 1 via the monitor 2.

The remote control 3 corresponds to an instructing means in accordance with the present invention, and is used by the user to scroll a map, and to answer a message for urging the user to do a certain operation which is outputted from the monitor 2 or the audio speaker 4. Instead of the remote control 3 or together with the remote control 3, a touch panel can be disposed for enabling the user to directly touch a touch sensor mounted on the screen of the monitor 2 to input various pieces of information. Furthermore, operation buttons (right/left buttons and forward/backward buttons) for inputting various pieces of information, and a voice recognition apparatus can also be disposed.

The audio speaker 4 outputs a route guidance message by voice according to an audio signal sent thereto from the navigation unit 1. The external memory 5 is optional, and is comprised of, for example, an HDD (Hard Disk Drive). Map data similar to map data stored in a recording medium 11a inserted into a disk drive unit 11 which will be mentioned below are stored in this external memory 5.

Next, the details of the navigation unit 1 will be explained. The navigation unit 1 is comprised of a control unit 10, the disk drive unit 11, a map data storage unit 12, a GPS (Global Positioning System) receiver 13, a speed sensor 14, a gyro sensor 15, a road information receiver 16, a route storage unit 17, a human-machine interface (abbreviated as an “HMI” from here on) unit 100, a map display unit 110, a map matching unit 120, a route searching unit 130, a route guidance unit 140, and a route generating unit 150. The route searching unit 130 is not an indispensable component for implementing the present invention, and can be removed from the navigation unit 1.

The control unit 10 is comprised of, for example, a microcomputer, and controls the whole of this navigation unit 1. The HMI unit 100, the map display unit 110, the map matching unit 120, the route searching unit 130, the route guidance unit 140, and the route generating unit 150 can consist of an application program which operates under the control of this microcomputer.

When the recording medium 11a, such as a DVD (Digital Versatile Disc) or a CD (Compact Disc), in which a map database including map data and intersection information is stored is inserted thereinto, the disk drive unit 11 plays back a content recorded in the recording medium. The map data are defined by nodes, road links, etc., and road information and destination area information which are included in the intersection information include pieces of link information, such as address (city, and chome (city district), banchi (city block) and number (house number)) data, road data about an intersection located forwardly in the traveling direction and another intersection located further forwardly, destination area name data, road sign image data, intersection construction links, famous facility data including famous facility areas, scenic spot data including scenic spot areas, road number data, place names, bridge names, tunnel names, the absolute geographic coordinates of a point of each place. The map data and the intersection information which are played back by this disk drive device 11 are sent to the map data storage unit 12.

The map data storage unit 12 temporarily stores the map data and the intersection information sent thereto from the disk drive unit 11 or the external memory 5. A map data storage means in accordance with the present invention is comprised of the disk drive device 11 or the external memory 5, and the map data storage unit 12. The map data and the intersection information stored in this map data storage unit 12 are used for display of a map and display of an intersection guide figure.

The GPS receiver 13 detects the current position of the vehicle on the basis of GPS signals from GPS satellites which are received via an antenna. Current position data showing the current position of the vehicle detected by this GPS receiver 13 are sent to the control unit 10. The speed sensor 14 detects the traveling speed of the vehicle on the basis of an external signal sent thereto from the vehicle in which this navigation apparatus is mounted. Speed data showing the traveling speed of the vehicle detected by this speed sensor 14 are sent to the control unit 10.

The gyro sensor 15 detects the traveling direction of the vehicle. Direction data showing the traveling direction of the vehicle detected by this gyro sensor 15 are sent to the control unit 10. The control unit 10 detects the current position of the vehicle with self-contained navigation on the basis of the speed data sent thereto from the speed sensor 14 and the direction data sent thereto from the gyro sensor 15. Because the navigation apparatus can detect the current position of the vehicle with self-contained navigation even if the navigation apparatus cannot detect the current position of the vehicle using the GPS receiver 13 when, for example, the vehicle is running through a tunnel or the like, the navigation apparatus can always detect the current position of the vehicle correctly.

The road information receiver 16 receives a road information signal transmitted from, for example, a road traffic data communications system. The road information signal received by this road information receiver 16 is sent to the control unit 10. The control unit 10 generates a message showing congestion information about congestion on roads on the basis of this road information signal, and notifies the message to the user via the monitor 2 and the audio speaker 4.

The route storage unit 17 stores a route generated by the route generating unit 150 separately from a route which the route searching unit 130 has searched for. The route stored in this route storage unit 17 is used for the route guidance and the guidance which are provided by the route guidance unit 140.

The HMI unit 100 processes either a command which is generated when the user manipulates a not-shown control panel or a command sent thereto from the remote control 3 via the monitor 2. This HMI unit 100 carries out communications between the navigation apparatus and the user. The map display unit 110 generates drawing data used for making the monitor 2 display a map, an intersection guide figure, etc. The drawing data generated by this map display unit 110 are sent to the monitor 2, so that a map and an intersection guidance figure are displayed on the screen of the monitor 2.

The map matching unit 120 matches the vehicle position generated on the basis of either the current position data from the GPS receiver 13 or the current position data generated from the speed data sent from the speed sensor 14 and the direction data sent from the gyro sensor 15 to the map shown by the map data read from the map data storage unit 12 so as to form a vehicle position mark on the map.

The route searching unit 130 searches for a route from the current position of the vehicle to the destination. As the vehicle travels, the route guidance unit 140 generates a route guidance figure showing road information about intersections located forwardly in the traveling direction, destination area information, famous facility or scenic spot area information, and so on, and a voice guidance message. The route guidance figure is displayed on the monitor 2, and the voice guidance message is outputted from the audio speaker 4.

When the user sequentially selects a destination area, a famous facility or scenic spot area, and so on from destination areas, famous facility or scenic spot areas, and so on shown in the route guidance figure displayed on the monitor 2 by using the remote control 3, the route generating unit 150 generates a route on the basis of the destination area, the famous facility or scenic spot area, and so on which are selected by the user. Therefore, in the route generation by this route generating unit 150, any input of a destination or the like is not needed, unlike in the route generation with the route search by the route searching unit 130. The route generated by this route generating unit 150 is stored in the route storage unit 17, as mentioned above.

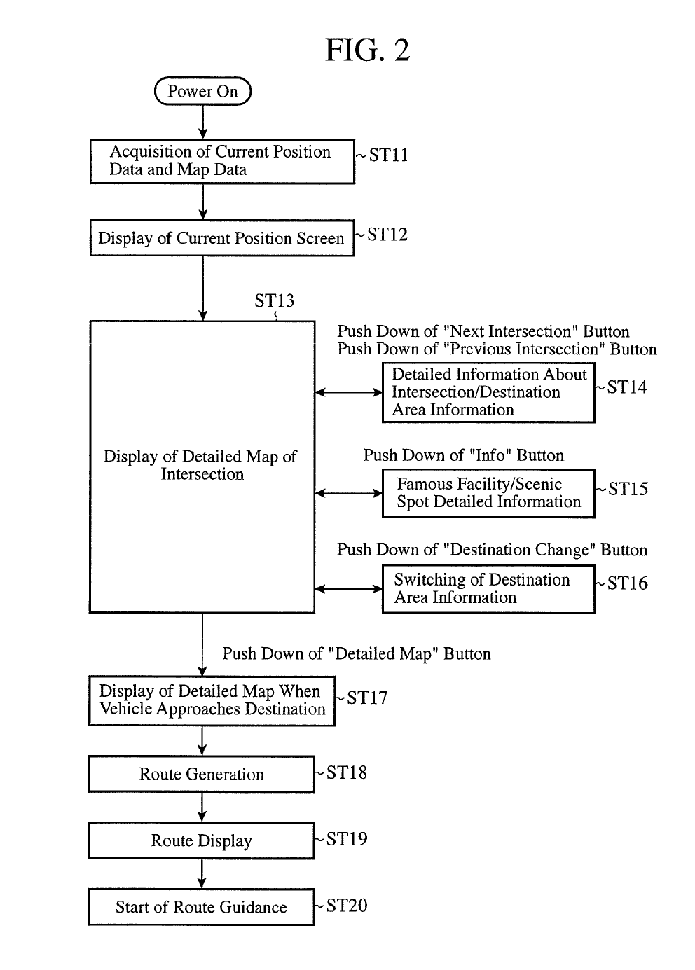

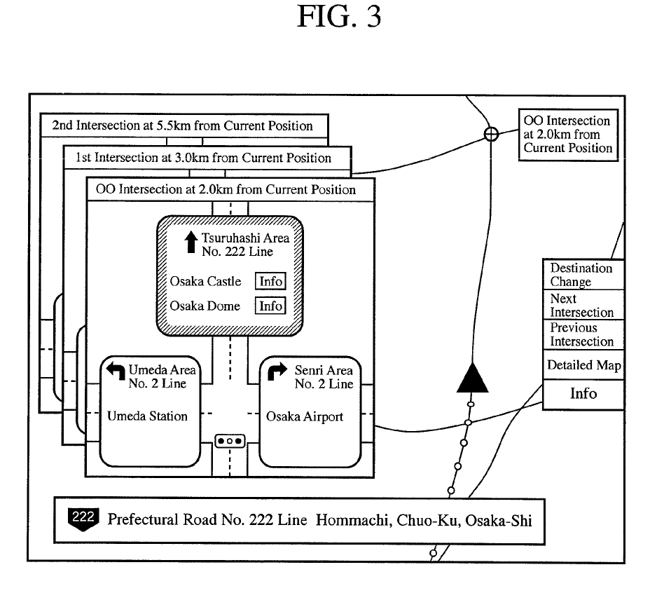

Next, the operation of the navigation apparatus which is constructed as mentioned above will be explained focusing on the route generating process with reference to a flow chart shown in FIG. 2, and screen display examples shown in FIGS. 3 to 9.

When the power supply of the navigation apparatus is switched on, the navigation apparatus acquires the current position data and map data first (step ST11). More specifically, the control unit 10 sends either the current position data acquired from the GPS receiver 13 or the current position data detected with autonomous navigation to the map matching unit 120. The disk drive unit 11 reads map data from the recording medium 11a set thereto, and stores them in the map data storage unit 12. The map matching unit 120 carries out a matching process of reading the map data from the map data storage unit 12, and superimposing the vehicle position mark on a map at a position corresponding to the current position data received from the control unit 10. The map data on which this matching process has been performed are sent to the map display unit 110. The map display unit 110 generates drawing data on the basis of the map data sent thereto from the map matching unit 120, and sends the drawing data to the monitor 2.

A display of a current position screen is then produced (step ST12). More specifically, the monitor 2 draws a map whose center corresponds to the current position of the vehicle on the basis of the display data received from the map display unit 110, and also generates drawing data on the basis of road information about intersections located forwardly in the traveling direction, destination area information, and famous facility or scenic spot area information included in the intersection information read from the map data storage unit 12, and sends the drawing data to the monitor 2. As a result, for example, a current position screen, as shown in FIG. 3, in which intersection guide figures of a plurality of intersections which exist in the traveling direction are superimposed on the map whose center corresponds to the current position is displayed on the monitor 2.

On the current position screen shown in FIG. 3, a map including the vehicle position mark (a triangular mark), a message showing the current position: “Prefectural road No. 222 Hommachi, Chuo-ku, Osaka-shi”, three intersection guide figures (OO intersection at 2.0 km from the current position, 1st intersection at 3.0 km from the current position, and 2nd intersection at 5.5 km from the current position), and a message “OO intersection at 2.0 km from the current position” showing the on-screen intersection guide figure are displayed. Furthermore, a “destination change” button, a “next intersection” button, a “previous intersection” button, a “detailed map” button, and an “Info” button are displayed on the current position screen. The user is enabled to select one of the buttons by using the remote control 3 to carry out a function allocated to the selected button, and the same goes for each screen which will be explained hereafter. An explanation will be made hereafter assuming that the user performs a selection of each button by using the remote control 3, though the navigation apparatus can be alternatively constructed in such a way as to enable the user to select a button by using a touch panel, right/left buttons and forward/backward buttons, voice recognition, or the like.

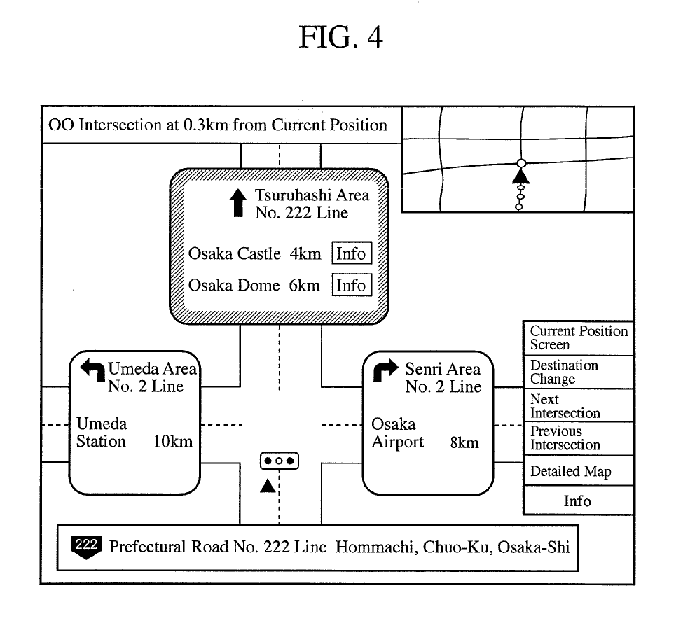

The user checks the traveling direction with reference to the monitor 2, and then selects a desired intersection guide figure from the plurality of intersection guide figures by using the remote control 3. Thereby, a detailed map of the selected intersection is displayed (step ST13). More specifically, as shown in FIG. 4, while the map on the current position screen shown in the FIG. 3, which has been being displayed on the monitor 2 till then, is reduced, the intersection guide figure is enlarged and displayed. At that time, the route generating unit 150 stores intersection position data showing the position of the intersection corresponding to the intersection guide figure which has been selected by the user by using the remote control 3 in the route storage unit 17. The position of the intersection shown by the intersection position data which are stored in the route storage unit 17 at that time is the place of departure of the route. Although the reduced map and the enlarged intersection guide figure are displayed in the example of the screen shown in FIG. 4, the navigation apparatus can be alternatively constructed in such a way as to enlarge and display only the intersection guide figure.

In the intersection guide figure shown in FIG. 4, when the “current position screen” button is pushed, the navigation apparatus returns to the normal current position screen as shown in FIG. 3. When the “next intersection” button is pushed on the current position screen shown in FIG. 3 or on the intersection guide figure shown in FIG. 4, the next intersection guide figure is displayed (step ST14). For example, when the “next intersection” button is pushed in a state in which the intersection guide figure of “OO intersection at 2.0 km from the current position” is displayed, the navigation apparatus switches to the intersection guide figure of “1st intersection at 3.0 km from the current position.” Similarly, when the “previous intersection” button is pushed, the navigation apparatus displays the previous intersection guide figure (step ST14). For example, when the “previous intersection” button is pushed in a state in which the intersection guide figure of “1st intersection at 3.0 km from the current position” is displayed, the navigation apparatus switches to the intersection guide figure of “OO intersection at 2.0 km from the current position.”

When the “next intersection” button or the “previous intersection” button is pushed in this step ST14, the route generating unit 150 stores position data showing the position of the intersection corresponding to the intersection guide figure which has been selected by the user by pushing the “next intersection” button or the “previous intersection” button in the route storage unit 17. While the user can obtain road information about an arbitrary intersection, destination area information, famous facility or scenic spot area information, or the like by manipulating this “next intersection” button or “previous intersection” button, the user can use the intersection as a part of the route. The “next intersection” button and the “previous intersection” button construct the instructing means in accordance with the present invention in cooperation with the above-mentioned remote control 3.

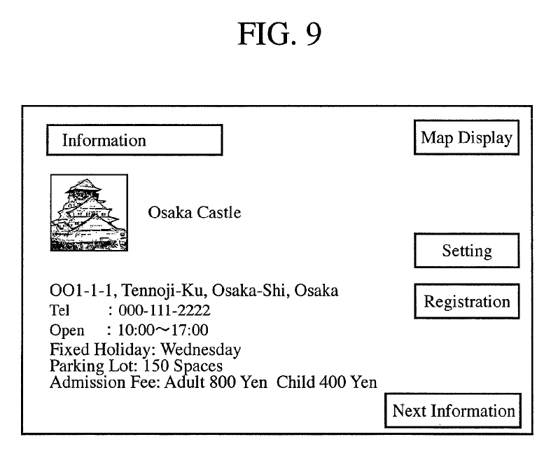

When the “Info” button is pushed by the user by using the remote control 3 on the current position screen shown in FIG. 3 or on the intersection guide figure shown in FIG. 4, for example, detailed information about a famous facility or a scenic spot with an “Info” mark attached thereto which is shown in the intersection guide figure at that time (in the example shown in FIG. 9, Osaka Castle and Osaka Dome) is displayed on a detailed information screen as shown in FIG. 9 (step ST15). The “Info” button corresponds to an information output instructing means in accordance with the present invention. The detailed information includes, for example, an address, a telephone number, opening dates, presence or absence of a parking lot, an admission fee, etc.

A “map display” button, a “setting” button, a “registration” button, and a “next information” button are disposed on the detailed information screen shown in FIG. 9. The “map display” button is used in order for the user to make the navigation apparatus return to either the current position screen or an intersection guide figure. The “setting” button is used in order for the user to make the navigation apparatus set up a point for which detailed information is displayed as a destination at the time of a route search, or the like. The “registration” button is used in order for the user to make the navigation apparatus register a point for which detailed information is displayed in the navigation apparatus. The “next information” button is used in order for the user to make the navigation apparatus display the next detailed information, for example, to switch from a state of displaying the detailed information about Osaka Castle to a state of displaying the detailed information about Osaka Dome.

When the “destination change” button is pushed by the user by using the remote control 3 on the current position screen shown in FIG. 3 or on the intersection guide figure shown in FIG. 4, the navigation apparatus switches to a screen of an area in a direction different from the traveling direction in the state, e.g., a direction in which the vehicle will be headed when making a left or right turn at an intersection located forwardly in the traveling direction (step ST16). The “destination change” button constructs the instructing means in accordance with the present invention in cooperation with the above-mentioned remote control 3. At that time, the route generating unit 150 stores intersection position data showing the position of an intersection which exists in the traveling direction, which has been changed by the user by pushing the “destination change” button by using the remote control 3, in the route storage unit 17. Thereby, the user can adopt the intersection as a part of the route while being able to make the navigation apparatus display road information about an intersection in a direction different from the traveling direction, destination area information, famous facility or scenic spot area information, etc.

The route generating unit 150 can be constructed in such a way as to, when generating the route, estimate that an intersection which is located further forwardly from the intersection located forwardly in the traveling direction is on an extension of the road along which the vehicle is currently traveling, estimate that, when roads branch from the road, an intersection which is located further forwardly from the intersection located forwardly in the traveling direction is on a road branching from the road and having a higher degree of road type classification (function class) condition, or estimates that, when roads branch from the road and have the same degree of road type classification condition or the like, an intersection which is located further forwardly from the intersection located forwardly in the traveling direction is on a road which branches from a side of a vehicle traffic lane of the road (e.g., in the case of left-hand traffic, a left-hand side of the road).

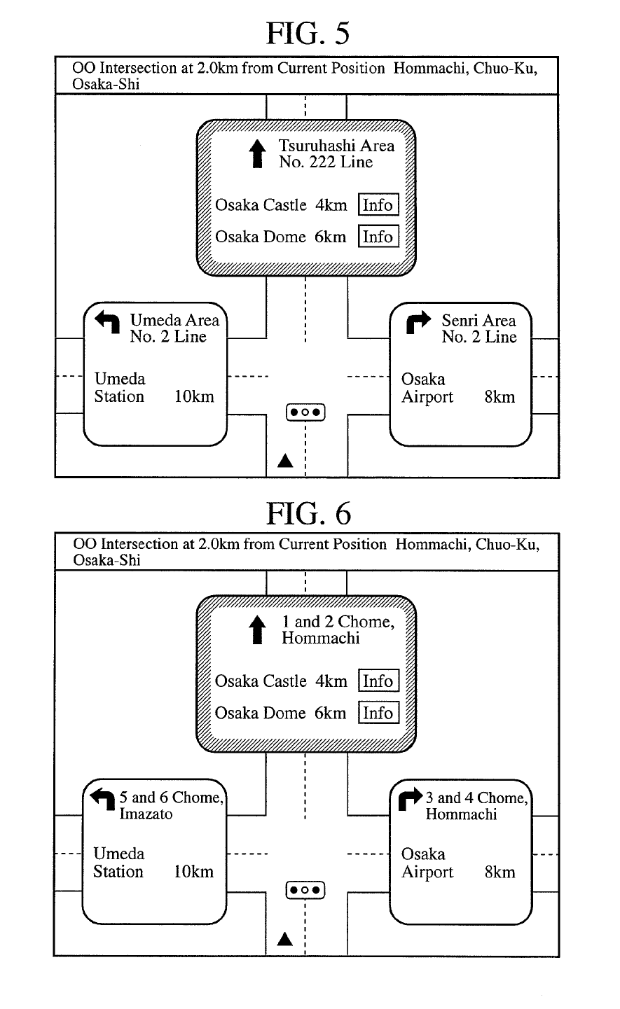

When the user pushes the “detailed map” button on the current position screen shown in FIG. 3 or on the intersection guide figure shown in FIG. 4 by using the remote control 3, the navigation apparatus changes the screen of the monitor 2 to a display of a detailed map (step ST17). The “detailed map” button corresponds to a detailed map instructing means in accordance with the present invention. If the navigation apparatus is, for example, in a state in which it displays the current position screen as shown in FIG. 5 in the process of this step ST17, the navigation apparatus switches to a screen on which detailed information as shown in FIG. 6 is displayed. More specifically, the navigation apparatus changes “Tsuruhashi area No. 222 line”, “Umeda area No. 2 line”, and “Senri area No. 2 line”, each of which is destination area information, to “1 and 2 Chome, Hommachi”, “5 and 6 Chome, Imazato”, and “3 and 4 Chome, Hommachi” which are concrete addresses, respectively.

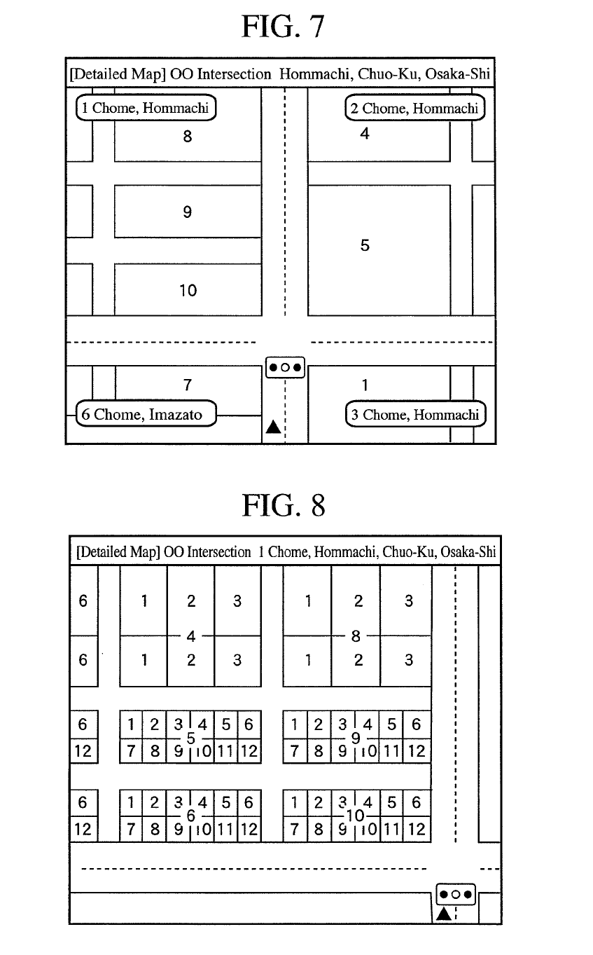

In contrast, if the navigation apparatus is in a state in which it displays the detailed information as shown in FIG. 6, the navigation apparatus switches to a screen on which a detailed map as shown in FIG. 7 is displayed. Furthermore, if the navigation apparatus is in a state in which a detailed map as shown in FIG. 7 is displayed, the navigation apparatus switches to a screen on which a further-detailed map as shown in FIG. 8 is displayed. Thereby, the navigation apparatus can display a detailed map about an area in a neighborhood of a final destination which the user desires. The navigation apparatus can also be constructed in such a way as to automatically display a detailed map according to the road category type of a position which is to be displayed or residential street area information about the position.

When the navigation apparatus repeats the above-mentioned operation and the user then reaches an intersection close to the point which the user desires (the final destination), the navigation apparatus then performs generation of the route (step ST18). More specifically, the route generating unit 150 generates the route from the place of departure to the final destination by connecting the positions shown by the intersection position data which have been sequentially stored in the route storage unit 17 with one another, and stores the route in the route storage unit 17. The navigation apparatus then performs a display of the route (step ST19). More specifically, the navigation apparatus displays the route stored in the route storage unit 17 on the screen of the monitor 2. After that, the navigation apparatus starts a route guidance (step ST20). More specifically, the route guidance unit 140 reads the route stored in the route storage unit 17, and displays the intersection information included in the map data read from the map data storage unit 12 and provides a guidance while guiding the user along this read route.

As previously explained, the navigation apparatus in accordance with Embodiment 1 of the present invention is constructed in such a way as to repeat the operation of instructing the traveling direction at an intersection by selecting a piece of information from among plural pieces of destination area information included in intersection information and plural pieces of famous facility or scenic spot area information, which are displayed on the monitor 2, connect intersections which the navigation apparatus has selected sequentially with one another so as to generate and store a route, and perform a route guidance along this stored route and provide a guidance. Therefore, the navigation apparatus can acquire a route which is extending up to a destination or a via-place which the user desires even if the navigation apparatus does not set up the destination or the via-place. For example, the navigation apparatus can generate a route by instructing the user who does not know the route to the destination or the via-place to make a left or right turn at the next intersection. Although a route which a navigation apparatus automatically determines does not meet the user's intention, the navigation apparatus in accordance with the present invention can set up a route which meets the user's intention.

### INDUSTRIAL APPLICABILITY

As mentioned above, because the navigation apparatus in accordance with the present invention generates a route on the basis of a destination area which is selected from among a plurality of destination areas included in intersection information displayed at each intersection, and performs a route guidance along the route and provides a guidance, the navigation apparatus can acquire a route which is extending up to a destination or a via-place which the user desires even if the navigation apparatus does not set up the destination or the via-place. Therefore, the navigation apparatus is suitable for use as a vehicle-mounted navigation apparatus or the like.

1. A navigation apparatus comprising:
a map data storage means for storing map data;
a display means for displaying intersection information including information about a plurality of destination areas at an intersection located forwardly in a traveling direction on a basis of map data read from said map data storage means;
an instructing means for instructing said traveling direction by selecting one destination area from the information about the plurality of destination areas included in the intersection information displayed on said display means;
a route generating unit for generating a route on a basis of destination areas which are selected sequentially under instructions provided by said instructing means;
a route storage unit for storing the route generated by said route generating unit; and
a route guidance unit for guiding along the route stored in said route storage unit, and for providing a guidance.

2. The navigation apparatus according to claim 1, characterized in that the display means also displays intersection information about another intersection located further forwardly from the intersection located forwardly in the traveling direction.

3. The navigation apparatus according to claim 1, characterized in that after one destination area at the intersection is selected under an instruction provided by the instructing means, the display means identifies the traveling direction on a basis of intersection construction links of said intersection, and displays intersection information about an intersection located forwardly in the identified traveling direction.

4. The navigation apparatus according to claim 1, characterized in that the map data storage means stores intersection information including address data, road data about an intersection located forwardly in the traveling direction, and other intersections located further forwardly from the intersection, destination area name data, road sign image data, intersection construction links, famous facility data including famous facility area names, scenic spot data including scenic spot area names, road number data, place names, bridge names, tunnel names, and geographic coordinates of places, and the route guidance unit displays intersection information read from said map data storage means to provide a guidance while guiding along the route stored in the route storage unit.

5. The navigation apparatus according to claim 1, characterized in that the route generating unit estimates other intersections located further forwardly from the intersection located forwardly in the traveling direction, and the display means displays pieces of intersection information about the other intersections estimated by said route generating unit by switching among them in turn on a basis of the map data read from the map data storage means.

6. The navigation apparatus according to claim 1, characterized in that the navigation apparatus includes a detailed map instructing means for providing an instruction for switching to a detailed map, and, when said detailed map instructing means provides the instruction for switching to a detailed map, the display means reads map data about a map of an area in a neighborhood of a location of an address included in the intersection information displayed from the map data storage means, and displays a detailed map on a basis of the map data read thereby.

7. The navigation apparatus according to claim 1, characterized in that the display means reads map data about a map of an area in a neighborhood of a location of an address included in the intersection information displayed from the map data storage means, and automatically displays a detailed map according to either a road category type or residential area information which is shown by the map data read thereby.

8. The navigation apparatus according to claim 1, characterized in that the navigation apparatus includes an information output instructing means for providing an instruction for outputting information, and, in a case of displaying either a famous facility or a scenic spot area included in the intersection information, the display means displays detailed information about either the famous facility or the scenic spot when said information output instructing means provides the instruction for outputting information.

9. The navigation apparatus according to claim 1, characterized in that the display means changes the traveling direction according to an instruction provided by the instructing means, and displays intersection information about an intersection located forwardly in said changed traveling direction.

10. The navigation apparatus according to claim 1, characterized in that the route generating unit estimates that the other intersections located further forwardly from the intersection located forwardly in the traveling direction exist on an extension of a road extending up to the intersection located forwardly in the traveling direction, and estimates that, when roads branch from the intersection located forwardly in the traveling direction, the other intersections located further forwardly from the intersection located forwardly in the traveling direction exist on a road having a higher degree of road type classification condition or a road which branches from a side of a vehicle traffic lane if the roads branching from the intersection have a same degree of road type classification condition.
